(19) United States
(12) Patent Application Publication
(10) Pub. No.: US 2006/0023750 A1
(43) Pub. Date: Feb. 2, 2006

(54) Method and system for transporting and switching traffic data with Quality of Service

(76) Inventors: Hyong Sok Kim, Pittsburgh, PA (US); Alberto Leon-Garcia, Toronto (CA)

Correspondence Address: Hyong S. Kim, 536 Colquitt Dr., Pittsburgh, PA, 15238, US

(21) Appl. No.: 11/161,155

(22) Filed: Jul. 25, 2005

Related U.S. Application Data
(60) Provisional application No. 60/591,867, filed on Jul. 29, 2004.

(51) Int. Cl. H04J 3/24

(52) U.S. Cl. 370/473

(57) ABSTRACT

A method, “transparent switching”, is disclosed that enables the transfer of packet and TDM information flows on circuits between ports on interfaces to a network. These circuits consist of fixed-length transparent switching frames that occur at a provisioned fixed repetition rate. In the network interfaces, arriving flows from outside the network are groomed and mapped into circuits, using mapping procedures disclosed herein, that carry traffic to one or more destination network interfaces. Inside the network, circuits can be switched and multiplexed either on the basis of data containers, “transparent switching frames,” or on the basis of underlying transport technologies. The traffic flows that arrive at a destination interface from inside the network are removed from the transparent switching frames and delivered to the appropriate egress port. In networks that must carry a preponderance of packet traffic, transparent switching provides a simple means of providing delay and bandwidth guarantees to specific traffic flows. Transparent switching also provides for the establishment of signaling channels and for mechanisms for the rapid setup of circuits.

This application is a utility patent application of our provisional patent application No. 60/591,867.

### OTHER REFERENCES

ITU-T G.7041/Y.1303, Generic Framing Procedure, October 2003

ANSI T1.105, Synchronous Optical Network (SONET)—Basic Description including Multiplex Structure, Rates and Formats

IETF RFC: 3945, E. Mannie et al, Generalized Multi-Protocol Label Switching (GMPLS) Architecture, October 2004.

1. Field of Invention

The invention disclosed herein pertains to the transfer of information flows among client network elements that attach to the backbone of electrical and optical transport networks.

2. Description of the Related Art

There have been numerous efforts to consolidate network and switching architecture in order to simplify network operation and to reduce costs. The current trend to converge existing services such as voice, video, and internet, onto a single Internet Protocol (IP) infrastructure is growing with an ultimate goal of an all-IP router-based network. However, the existing infrastructure mostly consists of SONET and TDM network elements that also continue to grow. Although Internet has grown dramatically, its profitability for service providers is significantly lower than the private line services that are based on TDM networks. Furthermore, the use of circuit-oriented communications in backbone transport networks will continue with the deployment of all-optical networks that provide end-to-end optical connectivity.

In addition to economic factors, an IP-centric infrastructure has significant technical challenges in the delivery of Quality of Service (QoS) and scalability. Although there have been more than 20 years of research and development for QoS over Internet, there is still no satisfactory solution at present. The most difficult challenge in QoS is the delay guarantee. Although Internet offers relative priority services through Differentiated Services IP (DiffServ), firm delay and bandwidth guarantees are not feasible. Thus despite numerous advances in packet-oriented QoS methodologies, circuit-based methods remain the simplest and most reliable means for providing low-delay and low jitter data transport across backbone networks.

The advances in transmission speeds in backbone networks, from 10 Gbps to 40 Gbps and beyond, imply greater complexity in the processing of packets at these speeds. This packet processing provides routing, forwarding, QoS, and traffic engineering. Increasing transmission speed implies that network processing hardware must accomplish these processing tasks in smaller time intervals. However, at high transmission speeds packet processing at this level of granularity is not necessary. For example, ATM was originally designed for access speeds of approximately 50 megabits per second, so a 53-byte ATM cell would require 8 microseconds to fill and to transmit. Today a typical 1250 byte Ethernet frame at a 1 gigabit per second access speed requires approximately 10 microseconds. Since application requirements are based on absolute processing time, Ethernet frames today provide the same level of responsiveness as provided by ATM when it was conceived. As access and transport transmission speeds continue to increase, the optimal size of the data units that are processed and transferred inside backbone transport networks will also increase. We disclose in this application a method for the transfer of information across high-speed networks based on fixed-size data containers, called transparent switching frames that typically accommodate one or more entire packets. Transparent switching circuits (TSC's) consisting of fixed rate transfer of transparent switching frames across a network provide traffic engineering as well as QoS guarantees at reduced network complexity.

Transport systems have used fixed containers in a number of ways. SONET synchronous transmission systems transfer fixed-length frames between network elements that can add, drop, multiplex, and demultiplex TDM streams. Said TDM streams can carry network-layer packet traffic, e.g. Internet Protocol packets. The fixed-length container in SONET however is concerned primarily with transmission-oriented issues such as synchronization, byte stuffing, and transmission performance monitoring. In particular, the SONET container does not play a direct role in the handling of packet traffic.

The Generic Framing Procedure (GFP) provides methods for carrying various information types over byte-synchronous transport networks. GFP in its “frame-oriented” mode can carry variable-length data-link layer protocol data units such as Ethernet, PPP or HDLC. GFP also offers a “transparent mode” in data is carried in fixed-size containers over a byte-synchronous transport network. The GFP transparent mode is intended to provide a physical layer constant bit-rate transfer for computer storage devices such as Fiber Channel that generate information at a synchronous rate.

The transparent switching frames disclosed in this application represent a novel use of fixed-container frames for the transport of packet traffic. The transparent switching frames simplify traffic management by making low delay and guaranteed bandwidth much easier to provide. The transparent switching frames also provide independence from the underlying physical transport system, allowing the traffic management mechanisms above the transparent switching frame to be designed independently of specific physical layers. In contrast, when packet streams are mapped directly onto certain data link virtual circuits the scheduling performed on the packets streams may not be sufficient to provide end-to-end delay or bandwidth guarantees.

Transparent switching, as disclosed in this application, places packet processing at the edge of the network where incoming packet streams can be groomed and aggregated prior to transmission over transparent switching circuits. Methods and apparatus for performing packet processing prior to mapping onto fixed-length containers has been disclosed in Canadian Patent Application 2411860 (PCT Application PCT/CA2001/000827), where fixed-length containers, “megapackets”, are used to transfer packet streams across an optical switch fabric with multiple qualities of service. The transparent switching disclosed in this application applies the fixed-length container approach on an end-to-end network basis to simplify packet traffic management.

Other significant issues with IP-centric infrastructure are reliability and security. Predictable network operation is very difficult to attain due to the nature of best-effort delivery and despite the introduction of QoS mechanisms such as DiffServ. The complex routing mechanism in IP further reduces the software reliability as well. The state-less operation of routers simplifies the operation but introduces lack of accountability. Security breaches in Internet are hard to detect, isolate, and prevent due to the lack of accountability and traceability. Transparent switching, as disclosed in this application, provides end-to-end security across the network by applying security mechanisms, such as authentication and encryption, to the TSC's that traverse the network.

Predictability, accountability, and traceability are requirements that all point to connection-oriented communications. Time-Division-Multiplexing (TDM)-like infrastructures are best suited for these purposes and they already exist in most of today's network. With the advent of Generalized Multiprotocol Label Switching (GMPLS) control plane, the existing TDM and Optical Crossconnect (OXC) circuit-based infrastructure can be provisioned dynamically to carry various network services including IP traffic. In addition to QoS predictability, there is much to be gained in terms of cost, reliability, security. Lower capital cost is expected if the existing equipment is reused. However, more significantly, operational cost will be substantially lower by eliminating failures resulting from faults and security breaches.

We introduce a novel network technology, named “Transparent Switching”, that allows the existing network to scale not only in terms of capacity but also in providing new services without the high cost of existing network technologies. Transparent switching provides a uniform, circuit-based approach to the transfer of packet as well as constant-bit-rate streams across the backbone of communications networks. Transparent switching can provide delay and bandwidth guarantees in a simple straightforward manner as well as independence from specific physical layers. With Transparent Switching technology, we expect to dramatic reductions in equipment cost as well as increases in performance. More importantly, TS will provide new services for network carriers with predictable performance with reliability and security.

### SUMMARY OF INVENTION

A method, “transparent switching, is disclosed that enables the transfer of packet and TDM information flows among ports on interfaces to a network. Signaling procedures establish Transparent Switching Circuits (TSC's) between interfaces to the network. These TSC's consisting of fixed-length data containers, called transparent switching frames (TSFs), repeat at some provisioned fixed repetition rate. An information flow that arrives at one said network ingress port can be a packet stream (IP, Ethernet, Packet over SONET, ATM etc.) or a constant bit rate stream (TDM, SONET, etc.). In the network interfaces, arriving flows from outside the network are groomed and mapped into TSC's, using mapping procedures disclosed herein, that carry traffic to one or more destination network interfaces. Inside the network, TSC's can be switched and multiplexed either on the basis of data containers (TSFs) or on the basis of underlying transport technologies. The traffic flows that arrive at a destination interface from inside the network are removed from their TSFs and delivered to the appropriate egress port. Optionally, TSC's provide end-to-end network security through the application of cryptographic techniques at the network ingress and egress interfaces. In a context where a network must carry a preponderance of packet traffic, such as IP, and frame traffic, such as Ethernet, transparent switching provides a simple means of providing delay, bandwidth, and security guarantees to specific traffic flows. Transparent switching also provides for the establishment of signaling channels and for mechanisms for the rapid setup of TSC's. Transparent switching simplifies traffic engineering by enabling the use of circuit switched network methodologies for traffic engineering and protection and restoration. At the same time, transparent switching can also provide the capabilities of label-switched packet network methodologies as well independence from the underlying physical layer.

### BRIEF DESCRIPTION OF THE DRAWINGS

FIG. 1. Transparent Switching Architecture

FIG. 2. Distributed Signaling Plane

FIG. 3. Centralized Signaling Plane

FIG. 4. Transparent Switching Frame

FIG. 5. Transparent Switching Datapath for Ingress TDM Type Interface

FIG. 6. Transparent Switching Datapath for Egress TDM Type Interface

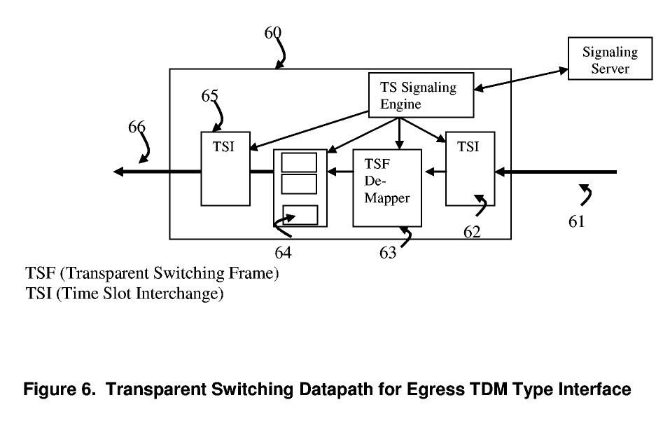

FIG. 7. Transparent Switching Datapath for Ingress packet type Interface

FIG. 8. Transparent Switching Datapath for Egress packet type Interface

FIG. 9. Transparent Switching System Implementation Options

FIG. 10. Transparent Switching System Implementation Option 1

FIG. 11. Transparent Switching System Implementation Option 2

FIG. 12. Transparent Switching System Implementation Option 3

FIG. 13. Transparent Switching System Implementation Option 4

### DETAILED DESCRIPTION OF THE INVENTION

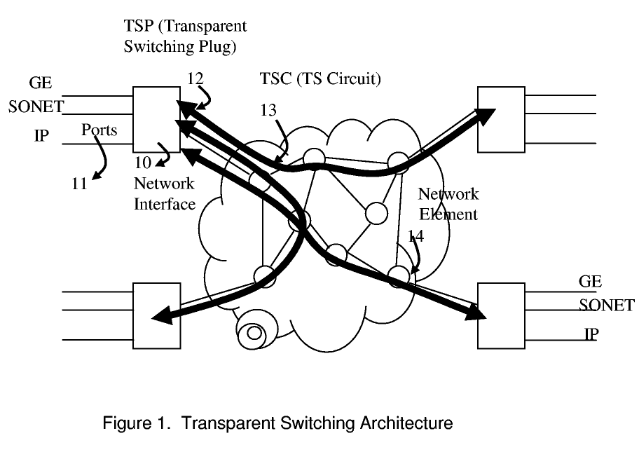

Transparent switching places a network interface 10 between the client network and the transport network as shown in FIG. 1. Information arrives from and departs to client network elements at ports 11 in the network interfaces. The information arriving from the client networks may be of TDM type or of packet type. Packet type traffic includes but is not limited to IP packets, Ethernet Frames, Frame Relay frames. TDM type traffic includes but is not limited to SONET tributaries, DS1, and DS3 traffic. Transparent switching circuits (TSC's) 13 transfer information between transparent switching plugs 12 in the network interfaces as shown in FIG. 1.

Transparent switching has two parts. A control part accepts requests from client networks for transfer of information between ports and configures interface and network resources to perform such transfers. A datapath part deals with the mapping of flows arriving at network ports into formats suitable for transfer in TSC's across the network.

The control part deals with the initialization of interfaces and associated ports, the definition of relationships between ports that are to exchange traffic, the discovery of port locations based on respective addresses, the establishment of paths between the ports through a routing algorithm, the configuration of interfaces and the establishment of TSC's and provisioning of associated bandwidth between interfaces. The processors that implement the control part exchange signaling messages to coordinate the execution of various control functions.

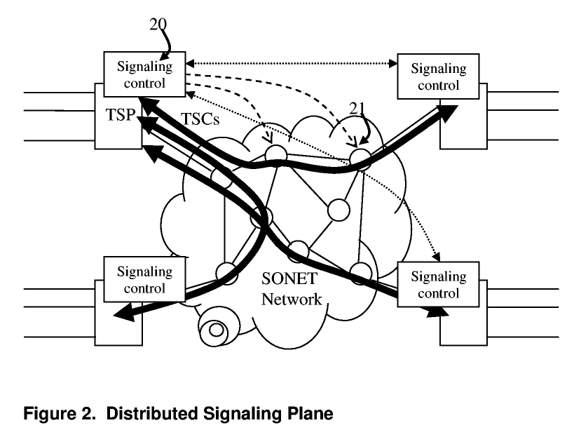

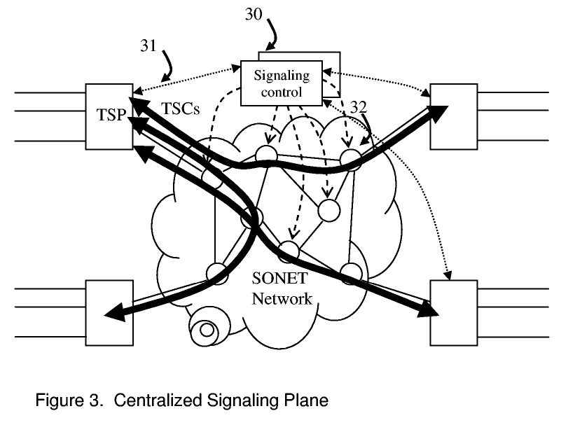

The control part 20 and datapath parts may be integrated in combined network elements that include the network interface as shown in FIG. 2. The control parts exchange signaling messages among themselves to carry out the various control functions. The control parts also exchange signaling messages with network elements 21 to set up the appropriate physical layer circuits to support the TSC's. Alternatively the control and datapath parts may be implemented separately. The control part resides in separate processors 30 and uses signaling messages to set up the TSC's between network interfaces 31 as well as to control the establishment of circuits 32 in the datapath part as shown in FIG. 3. The control part can be centralized or distributed as required.

The client networks place requests for a connection between a pair of network ports or for interconnection service between a set of network ports. The method for client networks placing said requests is outside the scope of this application. The signaling in the control part can establish circuits of specified bandwidth between network interfaces using a number of possible approaches. For example, the control part can use BGP for discovery of network interface associated with a given destination node in another client network, and GMPLS signaling for the establishment of circuits between interfaces. Alternatively, other well-known methods for the establishment of circuits across a network can be used.

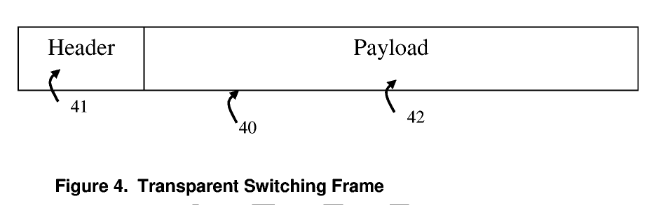

Transparent switching also provides a mechanism for the rapid setup of connections across the transport network. An optional signaling field in the header structure 41 in the Transparent Switching Frame 40 as shown in FIG. 4 provides a signaling channel that can be used for the exchange of signaling messages among network interfaces, network elements, and signaling processors in the backbone network. This signaling channel is present whenever a network element handles the transfer of at least one TSF. To ensure full signaling connectivity of network elements, interfaces and signaling processors, standby TSF circuits are set up to provide signaling connectivity to network interfaces and network elements that do not handle TSF circuits at some given point in time.

Fast circuit establishment can be accomplished as follows. Network elements and network interfaces are aware of the state of the network links through a routing protocol such as OSPF-TE as provided by the GMPLS. Ingress network interfaces can pre-compute paths to other egress network interfaces using the link state information provided by OSPF-TE. A network interface can then use the signaling channel to send a request for the establishment of a circuit along the particular path it has pre-computed. The request message is processed in parallel by the network elements involved in the path.

In transparent switching the datapath operates as follows. Information is transferred between network interfaces using Transparent Switching Circuits (TSC's) that consist of fixed-data containers, called Transparent Switching Frames (TSFs) that occur at fixed repetition rate. FIG. 4 shows the structure of said Transparent Switching Frame 40 to consist of a header section 41 that carries control information and of a payload 42 that carries the client information. The header may include addresses and/or labels that can be used to identify the circuit, its contents, or other pertinent control information. The header may also include cryptographic information to provide authentication, privacy, and other network security services. The bandwidth of a TSC between two interfaces is determined by the TSF repetition rate and TSF payload size. Multiple parallel TSC's may be established among ingress and egress interfaces to provide either higher bandwidth or greater reliability.

The header of the Transparent Switching Frame can include a signaling field that is used to transfer signaling messages between network interfaces, network elements, and signaling processors. The series of signaling fields in the TSFs of a circuit provide a constant bit rate signaling channel that allows the transfer of signaling messages between network interfaces, network elements, and signaling processors.

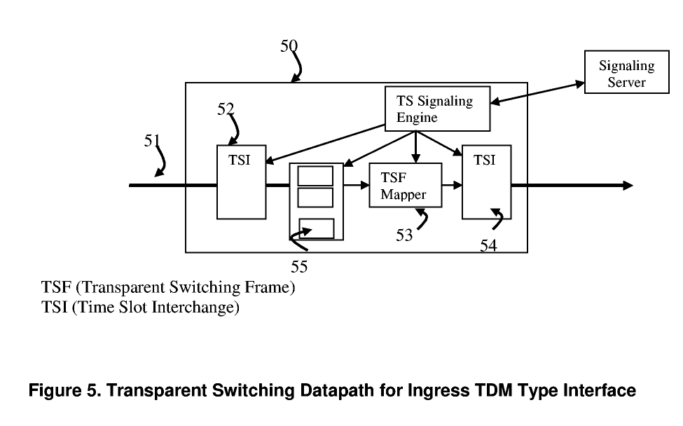

The network interface ports can be of two types: TDM or packet. As shown in FIG. 5, a TDM-type input port 51 accepts from a client network element TDM traffic that is to be transferred across the network to a TDM-type output port that connects to another client network element. The TDM traffic that arrives at an input port may contain multiple TDM substreams that are destined to different output ports in the network. The network interface uses Time Slot Interchange (TSI) 52 to accumulate different TDM substreams according to destination network interface 55 and to map 53 said TDM substreams into corresponding TSFs that belong to TSC's that have been established to the destination interface across the network. At the egress interface, transparent switching frames arriving from the network 61 are de-mapped 63 to recover the TDM substreams in 64 which can then be remultiplexed using TSI 65 and transmitted on an output TDM type egress port 66. In the special case where a TDM or SONET circuit carries the TSFs across the network, a second TSI 54 may be used to transfer the TSFs onto the appropriate TDM circuits at the ingress interface 54 and the egress interface 62.

The TSFs that carry TDM traffic between network interfaces can transport TDM substreams from different client networks that attach to the same ingress and egress network interfaces. This capability enables the service provider to perform multiplexing and concentration of the traffic that traverses its network.

In transparent switching the TSFs may be carried across the network in two possible ways. In the first approach, TSFs are carried end-to-end between network interfaces by synchronous connections using transport means such TDM, SONET, or optical wavelength connections. In this approach the interfaces can only perform multiplexing and concentration on the circuits that traverse the network. The underlying transmission technologies, e.g. TDM or SONET, can perform additional multiplexing and concentration at TDM or SONET circuit granularity.

A second approach to carrying TSFs involves network elements in the transport network that perform switching and multiplexing of TSFs. In this approach, a transport system carries TSFs between the network elements in FIG. 1. The TSFs can be carried by transmission systems such as TDM, SONET, optical wavelength or optical burst transmission. Said network elements switch TSFs along pre-established paths across the network to deliver low-latency transfer between network interfaces.

A packet-type port in a network interface accepts a stream of packets from a client network element and maps it into a format suitable for transfer in TSC's that have been established across the transport network to client network elements attached to output ports. When the port connection is initially established, the client and the network negotiate connection parameters. In general, this negotiation may include the bandwidth of the TSC across the network and the amount of buffering at the network interface to accommodate fluctuations in the packet arrival rate. These parameters are selected according to the packet delay and loss requirements as well as the arrival behavior of the packet stream. The interface may maintain performance statistics and provide regular reports, alarms when thresholds are exceeded, according to a service level agreement.

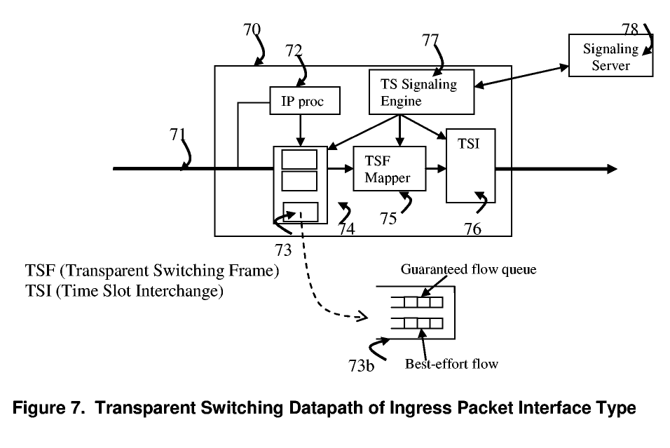

With reference to packet type interface 70 as shown in FIG. 7, a packet stream arrives on a single input port 71. The packets in the arriving stream may be destined to different output ports. Packet headers or labels and possibly payloads are examined by a packet processor 72 and a forwarding decision is made that specifies the next-hop output port or ports for the given packet. Each ingress interface maintains a Virtual Output Queue (VOQ) 73 for packets destined to each given egress network interface. A packet type interface may include more than one input port, and the IP processor 72 and virtual output queues 74 may be shared by the packet streams arriving in these multiple input ports. Each ingress interface is connected to appropriate egress interfaces by pre-established TSC's across the transport network. Each virtual output queue consists of two subqueues: a guaranteed flow subqueue and a best-effort flow subqueue as shown in the detail 73b. The guaranteed subqueue has guaranteed access to a pre-provisioned portion of the circuit bandwidth. If appropriate, the bandwidth utilized by the guaranteed flow may also be restricted to not exceed a certain level. The best effort queue has access to the residual bandwidth that is not used by the guaranteed flow. If appropriate the arriving packet streams may be policed, that is monitored, for conformance to pre-agreed arrival behavior and tagged or discarded as appropriate.

A mapper 75 retrieves packets from each VOQ and maps these into a corresponding Transparent Switching Frame (TSF), in preparation for transfer across a TSC to the egress interface of the corresponding output port. In the case where transport is provided by TDM or SONET circuits, these TSFs are placed in appropriate memory, and a Time Slot Interchange module 76 reads the TSFs into the corresponding outgoing TDM stream to the corresponding interface. In the case where TDM channelization is not used, for example in optical wavelength transmission, the TSI operation 76 is not present and containers are transferred serially over the given transmission system. At each egress interface, the arriving stream from the transport network may contain TDM substreams from different input ports. These TDM substreams and associated TSFs are recovered using TSI and the packet streams are recovered from the TSFs. The recovered packets are placed in two subqueues, for guaranteed priority traffic and best effort traffic. Packets are transmitted on the appropriate one or more output ports according to a given service discipline.

The operation of TDM and packet type datapath in network interfaces can be modified in a variety of ways to change the features of the transfer provided across the network. In one example, the use of authentication headers and the encryption of the TSF payload can provide secure and authenticated transfer end-to-end across a network. Appropriate modification in the control part is required to set up the necessary security associations between network interfaces. In another example, the IP processor may analyze multiple fields in the arriving header and even the contents of the payload prior to determining what action to take on each packet. In the case of filtering to thwart denial of service attacks or the spread of viruses, the said actions may include the discarding of packets. In other cases the said actions may involve a routing decision (e.g. egress network interface determination) according to the content in the headers and/or payloads of arriving packets. It is clear that in these cases the Virtual Output Queues 74 in FIG. 7 become special purpose queues according to the specific given processing and actions.

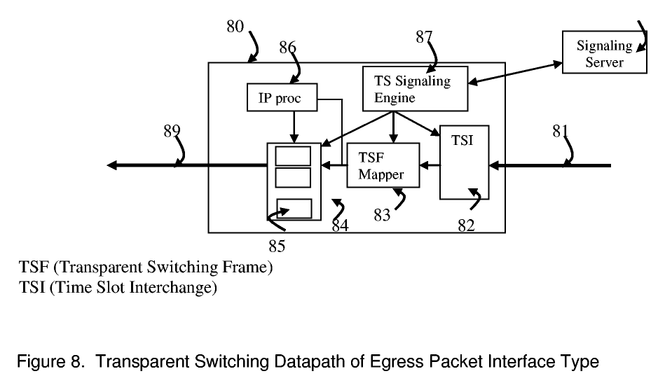

There are two approaches to mapping packets from VOQs to TSFs. In the first approach, a TSF may carry packets of different flow type that is guaranteed or best effort in 73b. The packets are read from the two subqueues according to a prescribed service discipline and mapped directly onto the sequence of TSFs that are destined to a given egress network interface. The service discipline can be selected to ensure that each flow type receives a certain amount of bandwidth. In each egress interface 80 in FIG. 8, packet streams arriving from different ingress interfaces are buffered as they are unpacked and reassembled from the arriving TSFs 83 and merged into a single packet stream that is transmitted on each output port 89 to the destination client network element. Alternatively the arriving packet streams can be buffered 85 and a variety of scheduling mechanisms may be used, as appropriate, in selecting the order in which arriving packets are read onto the output ports that connect to the client networks.

In transparent switching the bandwidth of the TSC's across the network are determined by the TSF repetition rate and the TSF payload size. The requirements of low-delay traffic flows can be met by configuring the said repetition rate so that the provisioned bandwidth exceeds the aggregate bandwidth of the low-delay traffic flows. Said circuit bandwidth provisioning can be performed for individual traffic flows between ports connecting client networks or for aggregated multiple flows that arrive from and are destined to different client networks.

In a second approach to mapping packets from VOQs to TSFs, each TSF carries packets of a single flow type. TSFs from a TSC are packed from the guaranteed flow subqueue according to a certain schedule. The rest of the TSFs in a TSC are made available to the best effort subqueue. If the guaranteed flow subqueue is empty when a TSF packing opportunity occurs, the entire TSF is then made available to the best effort queue. This second approach simplifies the unpacking of TSFs at the egress network interfaces. The approach also prevents the guaranteed flow traffic from using bandwidth in excess of its allocated amount.

The TSF in Transparent Switching simplifies the complexity of packet processing as well as the traffic management of packet flows across high-speed backbone networks. Packet scheduling and processing is performed only before packing onto TSFs and after unpacking from TSFs. Packet processing does not take place during the transfer of TSFs across the backbone network. The fixed repetition rate for TSFs guarantees low delay transfer across the backbone and hence the effectiveness of the packet scheduling in achieving desired delay performance is assured. It is in this sense, that transparent switching provides independence from the underlying transport system.

The TSF also enables the transport of TDM traffic in the same uniform manner as packet traffic. A simplification is possible in scenarios where the TDM traffic from client networks is of the same type as the underlying transport network that carries TSFs, for example when the TDM streams are of SONET type, and where a SONET network carries the TSFs. In this case, TDM traffic can be carried transparently by the transport network and the TSF mapping can be used exclusively for packet traffic.

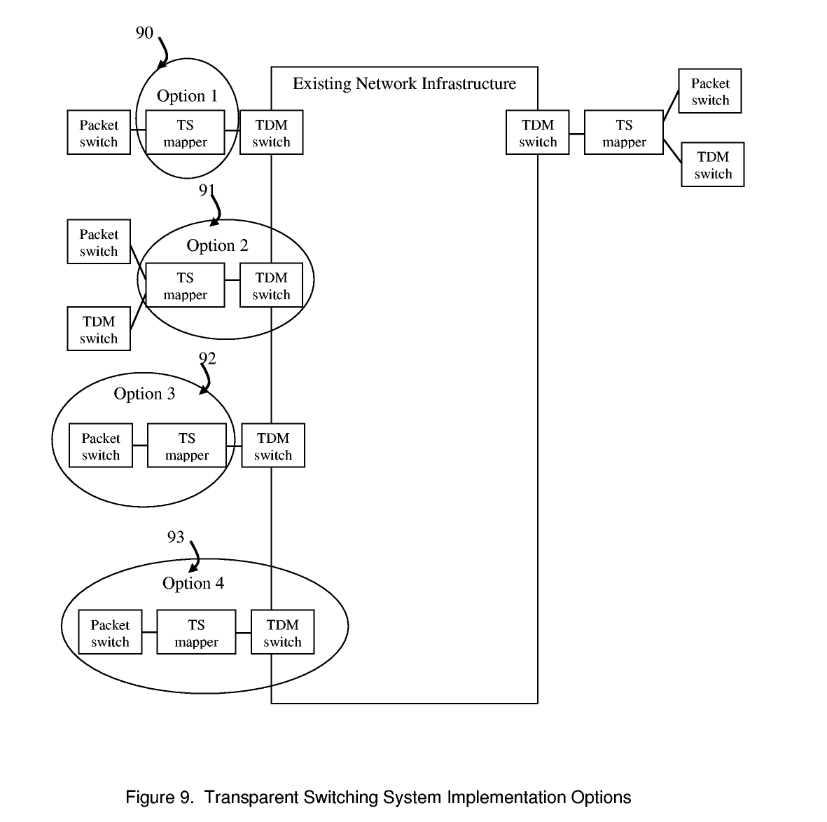

We now disclose several apparatuses to implement transparent switching systems ranging from a simple port mapper to a complete switching system including a packet switch or a TDM (SONET) cross-connect switch or both. FIG. 9 shows four options in Transparent Switching system implementations where the transport network that carries TSFs is TDM-based.

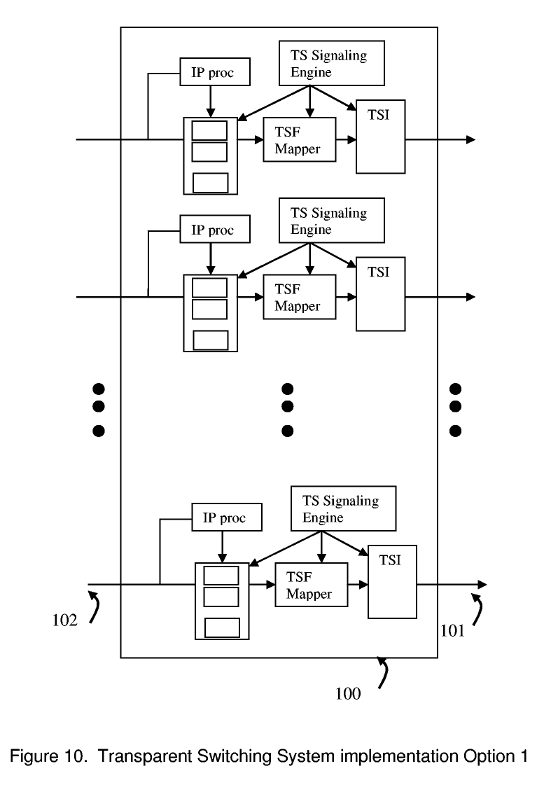

In Option 1, the transparent switching system 100 consists of a bank of port mappers 90 in FIG. 9, each with control plane processor 103 as shown in FIG. 10. Each ingress port 102 accepts packet traffic from a client network and maps it as appropriate into TSFs that are carried by TDM connections across the transport network. The interface shown in FIG. 10 only shows the mapping of packet streams. In Option 1, the traffic arriving on each port 102 has its own dedicated set of TDM connections 101 across the network. Option 1 defines a set of interfaces that can be attached to TDM switches to provide packet transfer capability.

A variation of Option 1 uses optical wavelength or optical burst circuits across the network to transfer TSFs. This variation does not require the TSI module in the port mappers.

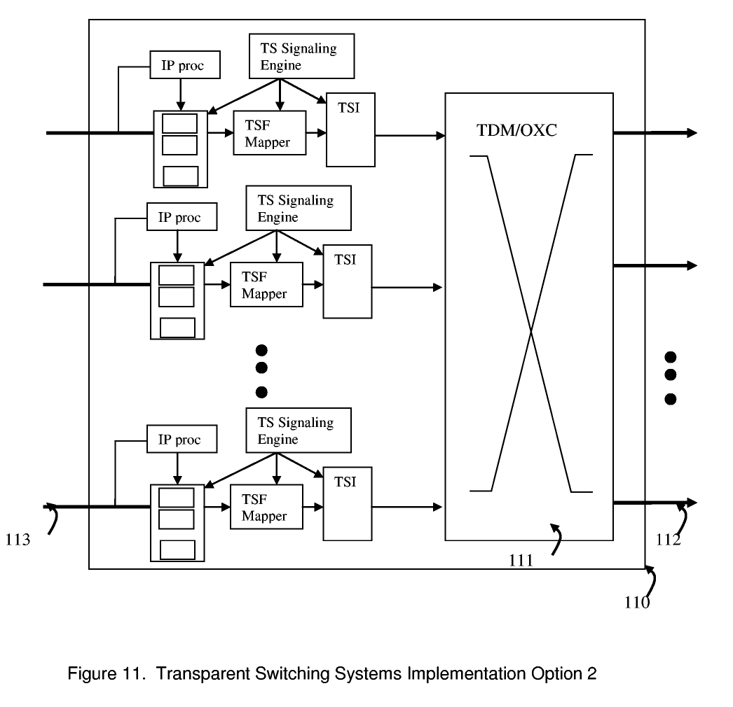

In Option 2, the transparent switching system 110 consists of a bank of port mappers interconnected by a TDM/OXC switch 111 that interfaces to the TDM/SONET/OXC network infrastructure as shown in FIG. 11. Option 2 allows the TDM connections originating at a network ports to be concentrated onto higher-speed TDM or optical connections 112 that traverse the network. Option 2 provides a means of integrating packet and TDM transfer capabilities onto a TDM switch architecture.

A variation of Option 2 uses a TDM/OXC crossconnect to concentrate TSFs onto optical wavelength or optical burst circuits 112 that traverse the network. A second variation of Option 2 replaces the TDM/OXC switch with an optical wavelength or an optical burst switch that interconnects TSFs originating in the port mappers to optical wavelength or optical burst circuits across the network. In the second variation of Option 2, the port mapper does not require the TSI module.

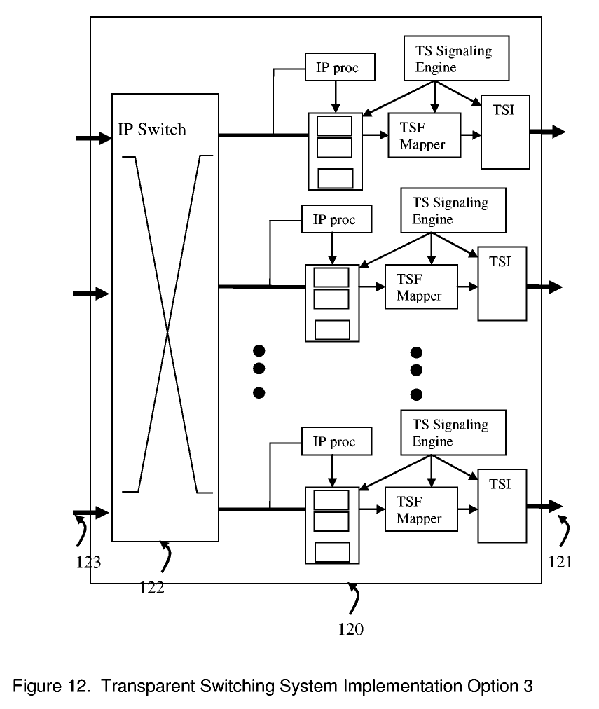

In Option 3, the transparent switching system 120 consists of a bank of mappers interconnected by a packet switch 122 (i.e. IP, MPLS, ATM, etc.) that interfaces to the client packet switching systems (i.e. IP, MPLS, ATM) as shown in FIG. 12. The packet switch in the interface can groom and concentrate packet traffic onto various TSF circuits according to egress network interface and other requirements. High packet multiplexing gains can result from the introduction of the packet switch. Option 3 provides a means for modifying a router through the introduction of interfaces to a TDM network.

A variation of Option 3 uses optical wavelength or optical burst circuits across the network to transfer TSFs. This variation does not require the TSI module in the mappers.

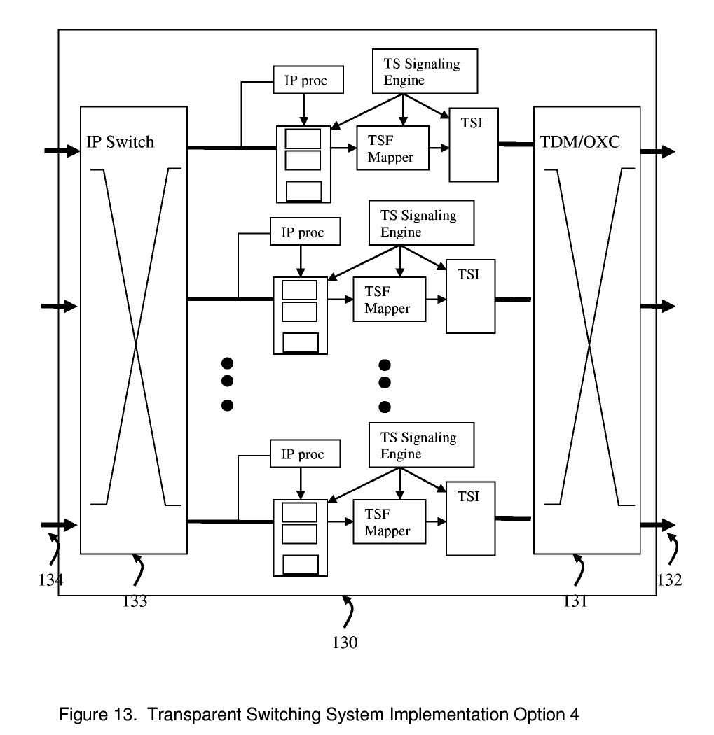

In Option 4, the transparent switching system 130 consists of a bank of mappers placed between a packet switch 133 at the ingress side and a TDM/OXC switch 131 at the network side as shown in FIG. 13. The packet switch 133 grooms and concentrates the arriving packet flows to provide packet-level multiplexing gain. The mappers map the concentrated packet streams onto TSFs. The TDM/OXC switch 132 concentrates the resulting TDM circuits onto high-speed trunks 132 that traverse the network. Option 4 defines a network element that combines the advantages of packet and circuit switching while simplifying the complexity of network operation.

A variation of Option 4 uses a TDM/OXC crossconnect to concentrate TSFs onto optical wavelength or optical burst circuits that traverse the network. A second variation of Option 4 replaces the TDM/OXC switch with an optical wavelength or an optical burst switch that interconnects TSFs originating the port mappers to optical wavelength or optical burst circuits across the network. In the second variation of Option 4, the mapper does not require the TSI module.

What is claimed is:

1. Transparent switching method in which information flows arriving from client networks to an ingress network node are aggregated by an ingress mapper onto fixed-size containers, “transparent frames”, that occur at a provisioned repetition rate, for transfer to one or more egress network nodes, where original flows are extracted from the aggregated stream.

2. Transparent switching method as in 1 where information flows arrive at a constant bit rate and are mapped onto transparent frames.

3. Transparent switching method as in 1 where information flows arrive as packets and are mapped and buffered in multiple queues.

4. Transparent switching method as in 3 where packets are buffered in multiple queues according to destination, or Quality of Service, reliability, security or other criterion.

5. Transparent switching method as in 4 where: transparent switching circuit provisioning provides guaranteed bandwidth and low latency transfer across the network; packets arriving at ingress node are analyzed using contents of packet headers, labels, or payload and assigned to and queued in a queue corresponding to network egress port; said queue is classified as being of type guaranteed flow or best effort flow; said packets in said queue are mapped onto assigned transparent circuits to corresponding network egress ports; where said assigned transparent switching circuits may be of type guaranteed flow or best effort flow; where transparent frames arriving at an egress network node are processed by an egress de-mapper to recover the packet streams destined for this node, where headers, labels or payloads are analyzed to determine the appropriate egress interface or interfaces that each packet should be forwarded to.

6. Transparent switching method as in 1, where transparent frames are carried from ingress network node to egress network node by a circuit established across a TDM or SONET transport network.

7. Transparent switching method as in 1 where transparent frames are carried from ingress network node to egress network node by an optical circuit established across an optical transport network.

8. Transparent switching method as in 1: where transparent frames are carried from ingress network node through a sequence of internal network switching nodes and then to an egress network node; said internal network switching nodes transferring transparent switching frames from switch ingress ports to switch egress ports according to a provisioned periodic transparent frame arrival and departure schedule.

9. Transparent switching method as in 1, where designated packet flows experience higher levels of reliability and availability through the establishment of redundant disjoint transparent switching circuits that simultaneously transfer the packet flow redundantly from the one or more ingress nodes to one or more egress nodes.

10. Transparent switching method as in 5: where designated large-volume packet flows receive higher network bandwidth through the establishment of multiple parallel circuits; where each said circuit transfers a portion of the packet flow from an ingress node to the egress node; where original large packet flows are reassembled at said egress node.

11. Transparent switching method as in 5 where signaling engines in ingress and egress node exchange messages with a central signaling server to coordinate the establishment, modification, and teardown of transparent switching circuits across the network.

12. Transparent switching method as in 5 where signaling engines in ingress and egress nodes exchange messages among themselves to determine the availability of bandwidth across the network, and to coordinate the establishment, modification, and teardown of transparent switching circuits across the network.

13. Transparent switching method as in 2: in which TDM flows arriving from client networks to an ingress network node are mapped by an ingress mapper onto transparent switching circuits for transfer across a network; where a TSC consists of transparent switching frames, that occur at a provisioned repetition rate; where TDM flows destined to the same egress node may be multiplexed and combined into an aggregate TDM flow; where component TDM flows are recovered from arriving transparent frames by an egress de-mapper at egress nodes and then buffered and forwarded to appropriate egress interface.

14. Transparent switching method as in 6: in which TDM flows arriving from client networks to an ingress network node are mapped directly onto TDM or SONET circuits for transfer across a network; where TDM flows are received at egress nodes and directly forwarded to appropriate egress interfaces.

15. Transparent switching method as in 1: where an ingress mapper handles a single information flow arriving at an ingress interface and maps it into multiple corresponding transparent switching circuits across the network to an egress network node; where a de-mapper at the egress node handles the multiple transparent switching circuits arriving from the network and merges these to recover the original information flow which is delivered from a single egress interface.

16. Transparent switching method as in 1: where an ingress mapper handles a single information flow arriving at an ingress interface and maps it into multiple transparent switching circuits across the network to multiple egress network nodes; where a de-mapper at the egress nodes recovers the original information flow which is delivered from one or more egress interfaces.

17. Transparent switching method and apparatus as in 1: where ingress and egress nodes include a TDM switch; where an ingress mapper handles a single packet flow arriving at an ingress interface and maps it into transparent switching frames that are carried by multiple TDM circuits that are input into the TDM switch; where said TDM switch grooms and aggregates the incident TDM circuits onto larger aggregated TDM circuits that flow from ingress network nodes to egress network nodes; where aggregated TDM circuits arrive from inside the network at a TDM switch that demultiplexes said aggregated TDM circuits and forwards said demultiplexed flows onto egress mapper; where an egress de-mapper handles the multiple packet flows arriving in circuits from the network and merges these into a single egress interface.

18. Transparent switching method and apparatus as in 17: where the TDM switch in an ingress node maps the aggregated TDM flows onto an optical circuit that is set up between the ingress node and the egress node; where the TDM switch in the egress node recovers the aggregated TDM flows from the optical circuit and inputs these into the TDM switch.

19. Transparent switching method and apparatus as in 1: where ingress and egress nodes include a packet switch; where each packet flow arriving from a client network is input into said packet switch; where said packet switch transfers packets from an ingress interface to a mapper that operates as in 1; where said packet switch can perform routing, load balancing, aggregation, grooming, or other traffic management functions.

20. Transparent switching method and apparatus as in 19 where ingress and egress nodes include a TDM switch that operates as in 17.
